(19) United States
(12) Patent Application Publication
(10) Pub. No.: US 2022/0081497 A1
(43) Pub. Date: Mar. 17, 2022

(54) CATALYST COMPONENTS FOR THE POLYMERIZATION OF OLEFINS

(71) Applicant: BASELL POLIOLEFINE ITALIA S.R.L., MILANO (IT)

(72) Inventors: BENEDETTA GADDI, FERRARA (IT); GIANNI COLLINA, FERRARA (IT); DANIELE EVANGELISTI, FERRARA (IT); OFELIA FUSCO, FERRARA (IT); PIERO GESSI, FERRARA (IT)

(73) Assignee: BASELL POLIOLEFINE ITALIA S.R.L., MILANO (IT)

(21) Appl. No.: 17/419,560

(22) PCT Filed: Dec. 19, 2019
(86) PCT No.: PCT/EP2019/086195

§ 371 Date: Jun. 29, 2021

(30) Foreign Application Priority Data
Jan. 9, 2019 (EP) 19151034.6

(51) Int. Cl. C08F 4/657; C08F 4/651

(52) U.S. Cl. CPC C08F 4/6574; C08F 110/06; C08F 2410/01; C08F 4/651

(57) ABSTRACT

A solid catalyst component for the polymerization of olefins made from or containing Mg, Ti, halogen, and an electron donor compound selected from glutarates, wherein the catalyst has specific porosity features.

### FIELD OF THE PRESENT DISCLOSURE

In general, the present disclosure relates to the field of chemistry. More specifically, the present disclosure relates to polymer chemistry. In particular, the present disclosure relates to catalyst components for the polymerization of olefins.

### BACKGROUND OF THE INVENTION

A family of propylene polymers includes heterophasic copolymers compositions made from or containing a relatively high crystallinity propylene polymer fraction and a low crystallinity elastomeric component. In some instances, the low crystallinity elastomeric component is a propylene-ethylene copolymer.

In some instances, these compositions are prepared by mechanical blending of the two main components. In some instances, these compositions are prepared via a sequential polymerization technique where the relatively high crystalline propylene polymer is prepared in a first polymerization reactor and then transferred to a successive polymerization reactor, where the low crystallinity elastomeric component is formed. Alternatively, the relatively high crystalline propylene polymer is referred to as “crystalline matrix.”

It is believed that the porosity of the relatively high crystallinity polymer matrix may affect the incorporation of the elastomeric fraction into the crystalline matrix, during the sequential polymerization process.

In some instances, the higher the porosity of the polymer matrix produced in the first step, the higher the amount of elastomeric component incorporated, within the matrix, in the second polymerization step.

In some instances, if the porosity of the matrix is poor, an excessive amount of elastomeric polymer fraction on the particles surface increases the tackiness of the particles, thereby giving rise to agglomeration phenomena. In some instances, the agglomeration leads to reactor wall sheeting, plugging, or clogging.

In some instances, crystalline polymers with a certain level of porosity are produced by polymerizing propylene with a catalyst having a certain level of porosity.

In some instances, such catalyst is obtained from adducts of formula MgCl₂.mEtOH.nH₂O where m is between 1 and 6 and n is between 0.01 and 0.6, from which a certain amount of alcohol is removed, thereby creating a porous precursor. The porous precursor is converted into a catalyst component by reaction with a titanium compound containing at least one Ti—Cl bond.

In some instances, the increase of the catalyst porosity leads to a decrease of polymerization activity.

### SUMMARY OF THE INVENTION

In a general embodiment, the present disclosure provides a solid catalyst component for the polymerization of olefins made from or containing Mg, Ti, halogen, and an electron donor compound selected from glutarates, wherein the catalyst having a total porosity (measured by mercury intrusion method), deriving from pores with radius up to 1000 nm, of at least 0.20 cm³/g and providing that more than 50% of the porosity derives from pores having radius from 1 to 100 nm.

### DETAILED DESCRIPTION OF THE INVENTION

In some embodiments, the total mercury porosity of the adduct ranges from 0.25 to 0.80 cm³/g, alternatively from 0.35 to 0.60 cm³/g.

In some embodiments, the porosity fraction deriving from pores having radius from 1 to 100 nm ranges from at least 50% to 90% of the total porosity, alternatively from 55.0 to 85%, alternatively from 60 to 80% of the total porosity.

In some embodiments, the glutarates have the formula (I):

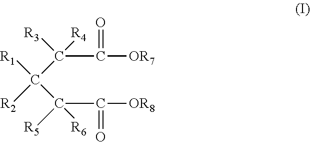

wherein the radicals R₁ to R₈ equal to or different from each other, are H or a C₁-C₂₀ linear or branched alkyl, alkenyl, cycloalkyl, aryl, arylalkyl or alkylaryl groups, optionally containing heteroatoms. In some embodiments, two or more of the radicals are joined to form a cycle, providing that R⁷ and R⁸ are both different from hydrogen.

In some embodiments, the glutarates are substituted glutarates wherein R₁ is H and R₂ is selected from linear or branched C₁-C₁₀ alkyl, cycloalkyl, aryl, arylalkyl and alkylaryl groups. In some embodiments, R2 is selected from linear or branched C1-C10 alkyls, cycloalkyl, and arylalkyl groups.

In some embodiments, the glutarates of formula (I) have both R₁ and R₂ different from hydrogen and selected from linear or branched C₁-C₁₀ alkyl, cycloalkyl, aryl, arylalkyl and alkylaryl groups. In some embodiments, both R₁ and R₂ are selected from C₂-C₅ linear alkyl groups.

In some embodiments, R₇ and R₈ are primary alkyl, arylalkyl or alkylaryl groups having from 1 to 10 carbon atoms. In some embodiments, R₇ and R₈ are primary branched alkyl groups having from 1 to 8 carbon atoms. In some embodiments, R₇ and R₈ are selected from the group consisting of methyl, ethyl, n-propyl, n-butyl, isobutyl, neopentyl, and 2-ethylhexyl.

In some embodiments, β-monosubstituted glutarate compounds are selected from the group consisting of diisobutyl 3-methylglutarate, diisobutyl 3-phenylglutarate, diethyl 3-ethylglutarate, diethyl 3-n-propylglutarate, diethyl 3-isopropylglutarate, diethyl 3-isobutylglutarate, diethyl 3-phenylglutarate, diisobutyl 3-ethylglutarate, diisobutyl 3-isopropylglutarate, diisobutyl 3-isobutylglutarate, diethyl 3-(3,3,3-trifluoropropyl)glutarate, diethyl 3-cyclohexylmethyl glutarate, and diethyl 3-tertbutyl glutarate.

In some embodiments, di or tri substituted glutarates are selected from the group consisting of diethyl 3,3-dimethylglutarate, diisobutyl 3,3-dimethylglutarate, diethyl 3-methyl-3-isobutyl glutarate, diethyl 3-methyl-3-t-butyl glutarate, diisobutyl 3-methyl-3-isobutyl glutarate, diethyl 3-methyl-3-phenyl glutarate, diethyl 3,3-di-n-propyl glutarate, diisobutyl 3,3-di-n-propyl glutarate, diethyl 3,3-diisobutylglutarate, diethyl 3-methyl-3-butyl glutarate, diethyl 3,3-diphenyl glutarate, diethyl 3-methyl-3-ethyl glutarate, diethyl 3,3-diethylglutarate, diethyl 3-methyl-3-isopropyl glutarate, diethyl 3-phenyl-3-n-butyl glutarate, diethyl 3-methyl-3-t-butyl glutarate, diethyl 3,3-diisopropyl glutarate diisobutyl 3-methyl-3-phenyl glutarate, diisobutyl 3,3-diisobutyl glutarate, diisobutyl 3-methyl-3-butyl glutarate, diisobutyl 3,3-diphenyl glutarate, diisobutyl 3-methyl-3-ethyl glutarate, diisobutyl 3,3-diethylglutarate, diisobutyl 3-methyl-3-isopropyl glutarate, diisobutyl 3-phenyl-3-n-butyl glutarate, diisobutyl 3-methyl-3-t-butyl glutarate, diisobutyl 3,3-diisopropyl glutarate, diethyl 3-ethyl-3 n butyl glutarate, diisobutyl 3-ethyl-3-n-butyl glutarate, diethyl 3-i-propyl-3-n-butyl glutarate, diisobutyl 3-i-propyl-3-n-butyl glutarate, diethyl 3-(2-methyl-butyl)-3-ethyl glutarate, diisobutyl 3-(2-methyl-butyl)-3-ethyl glutarate, diethyl 3-n-propyl-3-phenyl glutarate, diisobutyl 3-n-propyl-3-phenyl glutarate diethyl 2-methyl-3-phenyl glutarate, diethyl 2,2-dimethyl-3-phenyl glutarate, diethyl 2-methyl-3,3-diisobutyl glutarate, diethyl 2-ethyl-3-isopropylglutarate, diisobutyl 2-methyl-3-phenyl glutarate, diisobutyl 2,4-dimethyl-3-phenyl glutarate, diisobutyl 2-methyl-3,3-diisobutyl glutarate, and diisobutyl 2-ethyl-3-isopropylglutarate. In some embodiments, di or tri substituted glutarates are selected from the group consisting of diethyl 3,3-di-n-propyl glutarate and diisobutyl 3,3-di-n-propyl glutarate.

In some embodiments, glutarates having substituents R₁ and R₂ linked to form a cycle are selected from the group consisting of 9,9-bis(ethoxyacetyl)fluorene, 1,1-bis(ethoxyacetyl)cyclopentane, 1,1-bis(ethoxyacetyl)cyclohexane, and 1,3-bis(ethoxycarbonyl)-1,2,2-trimethylcyclopentane.

In some embodiments, the catalyst components of the present disclosure are made from or containing an adduct between magnesium chloride and alcohol containing from 3.5 to 4.5 moles of alcohol per mole of Mg. In some embodiments, the alcohol is ethanol.

In some embodiments, the adduct is prepared by contacting MgCl₂ and alcohol in the absence of the inert liquid dispersant, heating the system at the melting temperature of MgCl₂-alcohol adduct or above, and maintaining the conditions, thereby providing a completely melted adduct. In some embodiments, the adduct is kept at a temperature equal to or higher than the adduct's melting temperature, under stirring conditions, for a time period equal to, or greater than, 1 hour, alternatively from 2 to 15 hours, alternatively from 5 to 10 hours. The molten adduct is then emulsified in a liquid medium, which is immiscible with and chemically inert to the adduct, and finally quenched by contacting the adduct with an inert cooling liquid, thereby solidifying the adduct. In some embodiments and before recovering the solid particles, the solid particles are left in the cooling liquid at a temperature ranging from −10 to 25° C. for a time ranging from 1 to 24 hours. In some embodiments, the adduct is solidified into spherical particles by spraying the MgCl₂-alcohol adduct, not emulsified, in an environment having a temperature low enough to solidify rapidly the particles.

In some embodiments, MgCl₂ particles are dispersed in an inert liquid immiscible with and chemically inert to the molten adduct, the system is heated at temperature equal to or higher than the melting temperature of MgCl₂.ethanol adduct, and then alcohol is added in vapor phase. The temperature is kept at values such that the adduct is completely melted for a time ranging from 10 minutes to 10 hours. The molten adduct is then treated as described above. In some embodiments, the liquid in which the MgCl₂ is dispersed, or the adduct emulsified, is a liquid immiscible with and chemically inert to the molten adduct. In some embodiments, the liquid is aliphatic, aromatic or cycloaliphatic hydrocarbons or silicone oils. In some embodiments, the liquids are aliphatic hydrocarbons. In some embodiments, the liquid is vaseline oil.

In some embodiments, the quenching liquid is selected from hydrocarbons that are liquid at temperatures ranging from −30 to 30° C. In some embodiments, the quenching liquids are pentane, hexane, heptane or mixtures thereof.

In some embodiments, the molten adduct is solidified in discrete particles by using spray cooling technique wherein the solution is sprayed by a nozzle in a cold atmosphere and immediate solidification occurred.

In some embodiments, the solid adducts are made of compact particles with mercury porosity ranging from 0.05 to 0.12 cm³/g.

In some embodiments, the mercury porosity is increased by a dealcoholation step carried out as described in European Patent Application No. EP-A-395083, wherein dealcoholation is obtained by keeping the adduct particles in an open cycle fluidized bed created by the flowing of warm nitrogen which after removal of the alcohol from the adduct particles is directed out of the system. In this open cycle treatment, the dealcoholation is carried out at increasing temperature gradient until the particles have reached the alcohol content. In some embodiments, the resulting alcohol content is at least 10% (molar amount) lower than the initial amount.

In some embodiments, the partially dealcoholated adducts show a porosity ranging from-0.15 to 1.5 cm³/g depending on the extent of alcohol removed.

The particles collected at the end of the treatment are then reacted with a titanium compound and the glutarate, thereby forming the final solid catalyst component. In some embodiments, the titanium compounds have the formula Ti(OR^{a})ₙX_{y-n} wherein n is between 0 and y; y is the valence of titanium; X is chlorine and R^{a} is a hydrocarbon radical having 1-10 carbon atoms or a CORE group. In some embodiments, and R^{a} is an alkyl radical. In some embodiments, the titanium compounds have at least one Ti—Cl bond. In some embodiments, the titanium compounds are titanium tetrachlorides or chloroalcoholates. In some embodiments, the titanium compounds are selected from the group consisting of TiCl₃, TiCl₄, Ti(OBu)₄, Ti(OBu)Cl₃, Ti(OBu)₂Cl₂, and Ti(OBu)₃Cl. In some embodiments, the reaction is carried out by suspending the adduct in cold TiCl₄; then the mixture is heated up to 80-130° C. and kept at this temperature for 0.5-2 hours. In some embodiments, “cold” refers to 0° C. or lower. After the 0.5-2 hours, the excess of TiCl₄ is removed and the solid component is recovered. In some embodiments, the treatment with TiCl₄ is carried out one or more times.

In some embodiments, the solid catalyst component contains Ti atoms in an amount higher than 0.5% wt, alternatively higher than 1.0% wt, alternatively higher than 1.5% wt, with respect to the total weight of the catalyst component. In some embodiments, the amount ranges from 1.50 to 5% wt of titanium with respect to the total weight of the catalyst component.

In some embodiments, the solid catalyst component contains additional metal compounds. In some embodiments, the metal compounds are made from or containing elements belonging to group 1-15, alternatively groups 11-15, of the periodic table of elements (IUPAC version).

In some embodiments, the compounds include elements selected from Cu, Zn, and Bi not containing metal-carbon bonds. In some embodiments, the compounds are the oxides, carbonates, alkoxylates, carboxylates and halides of the metals. In some embodiments, the compounds are selected from the group consisting of ZnO, ZnCl₂, CuO, CuCl₂, and Cu diacetate. In some embodiments, the compounds are selected from the group consisting of BiCl₃, Bi carbonates and Bi carboxylates.

In some embodiments, the compounds are added during the preparation of the magnesium-alcohol adduct. In some embodiments, the compounds are introduced into the catalysts by dispersing the compounds into the titanium compound in liquid form which is then reacted with the adduct.

In some embodiments, the final amount of the metals into the final catalyst component ranges from 0.1 to 10% wt, alternatively from 0.3 to 8%, alternatively from 0.5 to 5% wt, with respect to the total weight of solid catalyst component.

In some embodiments, the electron donor compound (glutarate as internal donor) is added during the reaction between titanium compound and the adduct in an amount such that the ratio glutarate:Mg ranges from 1:4 and 1:20.

In some embodiments, the electron donor compound is added during the first treatment with TiCl₄.

In some embodiments, the final amount of glutarate in the solid catalyst component is such that glutarate's molar ratio with respect to the Ti atoms is from 0.01:1 to 2:1, alternatively from 0.05:1 to 1.2:1.

In some embodiments, the glutarate donor is added during the catalyst preparation process. In some embodiments, the glutarate donor is added in the form of precursors. In some embodiments and because of a reaction with other catalyst ingredients, the glutarate precursors are transformed into the compounds of formula (I). In some embodiments and in addition to the glutarate, the solid catalyst components contain additional donors. In some embodiments, the additional donors are selected from the group consisting of esters, ethers, carbamates, thioesters, amides and ketones.

In some embodiments, the ethers are 1,3-diethers of formula (II)

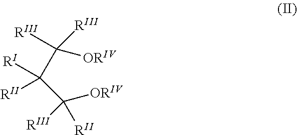

where R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups equal or different from each other, have the same meaning of R^{III} except that R^{IV} groups cannot be hydrogen. In some embodiments, R^{I} and R^{II} form one or more cyclic structures. In some embodiments, each of R^{I} to R^{IV} groups contains heteroatoms selected from the group consisting of halogens, N, O, S and Si.

In some embodiments, R^{IV} is a 1-6 carbon atom alkyl radical, alternatively methyl. In some embodiments, the R^{III} radicals are hydrogen. In some embodiments, R^{I} is methyl, ethyl, propyl, or isopropyl and R^{II} is ethyl, propyl, isopropyl, butyl, isobutyl, tert-butyl, isopentyl, 2-ethylhexyl, cyclopentyl, cyclohexyl, methylcyclohexyl, phenyl or benzyl. In some embodiments, R^{I} is hydrogen and R^{II} is ethyl, butyl, sec-butyl, tert-butyl, 2-ethylhexyl, cyclohexylethyl, diphenylmethyl, p-chlorophenyl, 1-naphthyl, or 1-decahydronaphthyl. In some embodiments, R^{I} and R^{II} are the same. In some embodiments, R^{I} and R^{II} are selected from the group consisting of ethyl, propyl, isopropyl, butyl, isobutyl, tert-butyl, neopentyl, phenyl, benzyl, cyclohexyl, and cyclopentyl.

In some embodiments, the ethers have the formula (III):

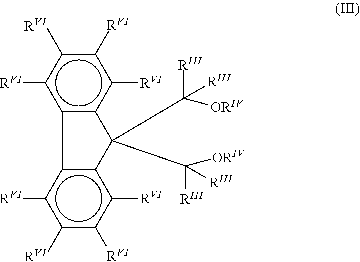

where the R^{VI} radicals equal or different are hydrogen; halogens; C1-C20 alkyl radicals, linear or branched; C₃-C₂₀ cycloalkyl, C₆-C₂₀ aryl, C₇-C₂₀ alkylaryl and C₇-C₂₀ arylalkyl radicals, optionally containing one or more heteroatoms selected from the group consisting of N, 0, S, P, Si and halogens as substitutes for carbon or hydrogen atoms, or both; the radicals R^{III} and R^{IV} are as defined above for formula (II). In some embodiments, the halogens are selected from the group consisting of Cl and F.

In some embodiments, the catalyst components of the present disclosure form catalysts for the polymerization of alpha-olefins CH₂═CHR, wherein R is hydrogen or a hydrocarbon radical having 1-12 carbon atoms, by reaction with an organoaluminum compound. In some embodiments, the organoaluminum compound is an Al-alkyl compound. In some embodiments, the alkyl-Al compound is a trialkyl aluminum compound. In some embodiments, the trialkyl aluminum compound is selected from the group consisting of triethylaluminum, triisobutylaluminum, tri-n-butylaluminum, tri-n-hexylaluminum, and tri-n-octylaluminum. In some embodiments, the alkyl-Al compound is selected from the group consisting of alkylaluminum halides, alkylaluminum hydrides, alkylaluminum sesquichlorides, and mixtures with trialkyl aluminum compounds. In some embodiments, the alkylaluminum sesquichlorides are selected from the group consisting of AlEt₂Cl and Al₂Et₃Cl₃.

In some embodiments, the molar ratio between alkyl-Al compound and Ti of the solid catalyst component ranges from 20:1 to 2000:1.

In some embodiments and for the stereoregular polymerization of α-olefins, an electron donor compound (external donor) is used in the preparation of the catalysts. In some embodiments, the α-olefins are selected from the group consisting of propylene and 1-butene. In some embodiments, the external donor is the same as the compound used as internal donor. In some embodiments, the external donor is different from the compound used as internal donor. In some embodiments, the internal donor is an ester of a polycarboxylic acid and the external donor is selected from the silicon compounds containing a Si—OR link, having the formula Rₐ¹R_{b}²Si(OR³)_{c}, where a and b are integer from 0 to 2, c is an integer from 1 to 3 and the sum (a+b+c) is 4; R¹, R², and R³, are alkyl, cycloalkyl or aryl radicals with 1-18 carbon atoms. In some embodiments, the ester of a polycarboxylic acid is a phthalate. In some embodiments, the silicon compounds have a is 1, b is 1, c is 2, R¹, R², or both are selected from branched alkyl, cycloalkyl or aryl groups with 3-10 carbon atoms and R³ is a C₁-C₁₀ alkyl group, alternatively methyl. In some embodiments, the silicon compounds are selected from the group consisting of methylcyclohexyldimethoxysilane, diphenyldimethoxysilane, methyl-t-butyldimethoxysilane, and dicyclopentyldimethoxysilane. In some embodiments, the silicon compounds have a is 0, c is 3, R² is a branched alkyl or cycloalkyl group and R³ is methyl. In some embodiments, the silicon compounds are selected from the group consisting of cyclohexyltrimethoxysilane, t-butyltrimethoxysilane and thexyltrimethoxysilane.

In some embodiments, the components and catalysts obtained therefrom are used in processes for the homopolymerization or copolymerization of olefins of formula CH₂═CHR wherein R is hydrogen or a hydrocarbon radical having 1-12 carbon atoms.

In some embodiments, the catalysts are used in slurry polymerization using as diluent an inert hydrocarbon solvent or bulk polymerization using the liquid monomer as a reaction medium. In some embodiments, the liquid monomer is propylene. In some embodiments, the catalysts are used in a polymerization process carried out in gas-phase operating in one or more fluidized or mechanically agitated bed reactors.

In some embodiments, the polymerization is carried out at temperature of from 20 to 120° C., alternatively of from 40 to 80° C. In some embodiments, the polymerization is carried out in gas-phase and the operating pressure is between 0.1 and 10 MPa, alternatively between 1 and 5 MPa. In some embodiments and in the bulk polymerization, the operating pressure is between 1 and 6 MPa, alternatively between 1.5 and 4 MPa.

The following examples are given to illustrate and not to limit the present disclosure.

### Characterization

Porosity and surface area with nitrogen: were determined according to the B.E.T. method (apparatus used SORPTOMATIC 1900 by Carlo Erba).

Porosity and Surface Area with Mercury:

The measurement was carried out using a “Pascal 240” series porosimeter by Carlo Erba.

The porosity was determined by intrusion of mercury under pressure. A calibrated dilatometer (capillary diameter 3 mm) CD3P (by Carlo Erba) connected to a reservoir of mercury and to a high-vacuum pump was used. A weighed sample was placed in the dilatometer. The apparatus was then placed under high vacuum (<0.1 mm Hg) for 20 minutes. The dilatometer was then connected to the mercury reservoir, and the mercury flowed slowly into the dilatometer until the mercury reaches the level marked on the dilatometer at a height of 10 cm. The valve that connected the dilatometer to the vacuum pump was closed, and the mercury pressure was gradually increased with nitrogen up to 140 kg/cm². Under the effect of the pressure, the mercury entered the pores and the level decreased according to the porosity of the material.

The porosity (cm³/g) (for supports and catalysts deriving from pores up to 1000 nm and for polymer up to 10000 nm) and the pore distribution curve were directly calculated from the integral pore distribution curve, which was function of the volume reduction of the mercury and applied pressure values. These data were provided and elaborated by the porosimeter associated computer, which was equipped with a dedicated Pascal software supplied by C. Erba.

The average pore size was determined as the weighted average by the pore distribution curve, and the values obtained by multiplying the relative volume (%) of each pore fraction in the range 0-1000 nm of the curve by the average pore radius of the fraction were added together and divided by 100.

### EXAMPLES

General Procedure for the Preparation of the Catalyst Component

Into a 1l steel reactor provided with a stirrer, 500 cm³ of TiCl₄ were introduced at room temperature, at 0° C. While stirring, 20 g of the adduct were introduced containing BiCl₃ (in amount to have a Mg/Bi molar ratio of 60). At 40° C. temperature, an amount of diethyl 3,3-di-n-propylglutarate as internal donor, thereby providing a Mg/donor molar ratio of 14, was introduced. The whole was heated to 110° C. over 58 minutes. The conditions were maintained over 50 minutes. The stirring was stopped. After 10 minutes, the liquid phase was separated from the sedimented solid, maintaining the temperature at 110° C. A further treatment of the solid was carried out adding 500 cm³ of TiCl₄ and an amount of diethyl 3,3-di-n-propylglutarate as internal donor to provide a Mg/donor molar ratio of 14. The mixture was heated at 110° C. over 10 min., and the conditions were maintained for 30 min under stirring conditions (500 rpm). The stirring was then discontinued. After 30 minutes, the liquid phase was separated from the sedimented solid, maintaining the temperature at 110° C. A further treatment of the solid was carried out, adding 500 cm³ of TiCl₄, heating the mixture at 110° C. over 10 min., maintaining the conditions for 15 min under stirring conditions (500 rpm). The stirring was then discontinued. After 10 minutes, the liquid phase was separated from the sedimented solid, maintaining the temperature at 110° C. Thereafter, 5 washings with 500 cm³ of anhydrous hexane at 90° C. and 1 washing with 500 cm³ of anhydrous hexane at room temperature were carried out. The solid catalyst component was then dried under vacuum in nitrogen environment at a temperature ranging from 40-45° C.

General Procedure for the Propylene Polymerization Test.

A 4 liter steel autoclave equipped with a stirrer, a pressure gauge, a thermometer, a catalyst feeding system, monomer feeding lines, and a thermostatic jacket, was used. The reactor was charged with 0.01 g of solid catalyst component 0.76 g of TEAL, 0.06 g of cyclohexylmethyldimethoxysilane, 3.2 l of propylene, and 2.0 l of hydrogen. The system was heated to 70° C. over 10 min. under stirring, and maintained under these conditions for 120 min. At the end of the polymerization, the polymer was recovered by removing any unreacted monomers and dried under vacuum.

### Example 1

In a vessel reactor equipped with a IKA RE 166 stirrer containing 963 g of anhydrous EtOH at −8° C., 530 g of MgCl₂ and 14 g of water were introduced under stirring. After the MgCl₂ was added, the temperature was raised to 108° C. and kept at this value for 20 hrs. While keeping the temperature at 108° C., the melt was fed by volumetric pump set to 62 ml/min together and OB55 oil fed was by volumetric pump set to 225 ml/min to an emulsification unit operating at 2800 rpm, thereby producing an emulsion of the melt into the oil. While the melt and oil were fed continuously, the mixture at about 108° C. was continuously discharged into a vessel containing 22 liters of cold hexane which was kept under stirring and cooled so that the final temperature did not exceed 12° C. After 24 hours, the solid particles of the adduct recovered were then washed with hexane and dried at 40° C. under vacuum. The compositional analysis showed that the particles contained 61.8% by weight of EtOH, 1.15% by weight of water, and the remaining being MgCl₂.

The adduct was then thermally dealcoholated in a fluidized bed under increasing temperature nitrogen flow until the content of EtOH reached a chemical composition of 57.3% wt EtOH and 1.2% wt H₂O, had a total porosity deriving from pores up to 1000 nm of 0.18 cm³/g, and had a fraction of porosity deriving from pores with radius up to 100 nm accounting for 47.1% of the total porosity.

Then, the dealcoholated adduct was used to prepare the catalyst component containing 16% wt of Mg, 1.8% wt of Ti, 1.1% wt of Bi, and 10% wt of glutarate, having a total porosity deriving from pores up to 1000 nm of 0.273 cm³/g, and having a fraction of porosity deriving from pores with radius up to 100 nm accounting for 66.6% of the total porosity.

The catalyst was then used in a polymerization test. The results are reported in Table 1.

### Comparative Example 1

The same procedure disclosed for example 1 was used, except diisobutyl phthalate was used instead of diethyl 3,3-di-n-propylglutarate. The resulting catalyst component contained 17.5% wt of Mg, 1.4% wt of Ti, 2.7% wt of Bi, and 8.5% wt of phthalate.

The catalyst was then used in a polymerization test. The results are reported in Table 1.

### Example 2

The adduct containing 57.3% by weight of EtOH and 1.2% wt of water prepared in example 1 was thermally dealcoholated in a fluidized bed under increasing temperature nitrogen flow until the content of EtOH reached a chemical composition of 50% wt EtOH and 1.2% wt H₂O, had a total porosity deriving from pores up to 1000 nm of 0.35 cm³/g, and had a fraction of porosity deriving from pores with radius up to 100 nm accounting for 29.1% of the total porosity.

Then, the dealcoholated adduct was used to prepare a catalyst component containing 16% wt of Mg, 1.7% wt of Ti, 1.1% wt of Bi, 7.9% wt of glutarate, having a total porosity deriving from pores up to 1000 nm of 0.517 cm³/g, and having a fraction of porosity deriving from pores with radius up to 100 nm accounting for 60.2% of the total porosity.

The catalyst was then used in a polymerization test. The results are reported in Table 1.

### Comparative Example 2

An initial amount of MgCl₂.2.8C₂H₅OH adduct was prepared as described in Example 2 of Patent Cooperation Treaty Publication No. WO98/44009, but operating on larger scale.

The adduct was then thermally dealcoholated under increasing temperature nitrogen flow until the content of EtOH reached a chemical composition of 49.8% wt EtOH and 1.3% wt of water.

Then, the dealcoholated adduct was used to prepare a catalyst component containing 15.5% wt of Mg, 1.5% wt of Ti, 0.9% wt Bi, and 9.1% wt of glutarate, having a total porosity deriving from pores up to 1000 nm of 0.545 cm³/g, and having a fraction of porosity deriving from pores with radius up to 100 nm accounting for 46.6% of the total porosity.

The catalyst was then used in a polymerization test. The results are reported in Table 1.

TABLE 1

| | | Melt | Polymer | Polymer bulk |
|---|---|---|---|---|
| | | Index | Porosity | Density |
| Example | I.I. | g/10′ | (cm³/g) | g/cm³ |
| 1 | 98.9 | 1.1 | 0.20 | 0.42 |
| Comp.1 | 99.4 | 1.2 | 0.17 | 0.44 |
| 2 | 99.0 | 1.4 | 0.30 | 0.40 |
| Comp.2 | 98.9 | 1.8 | 0.21 | 0.42 |

What is claimed is:

1. A solid catalyst component for the polymerization of olefins comprising Mg, Ti, halogen, and an electron donor compound selected from glutarates, wherein the catalyst having a total porosity (measured by mercury intrusion method), deriving from pores with radius up to 1000 nm, of at least 0.20 cm³/g, providing that more than 50% of the porosity derives from pores having radius from 1 to 100 nm.

2. The solid catalyst component of claim 1, wherein the total mercury porosity ranges from 0.25 to 0.80 cm³/g.

3. The solid catalyst component of claim 1, wherein the porosity fraction deriving from pores having radius from 1 to 100 nm ranges from at least 50% to 90% of the total porosity.

4. The solid catalyst component of claim 3, wherein the porosity fraction deriving from pores having radius from 1 to 100 nm ranges from 55% to 85% of the total porosity.

5. The solid catalyst component of claim 1, wherein the electron donor is selected from glutarates having the formula (I) 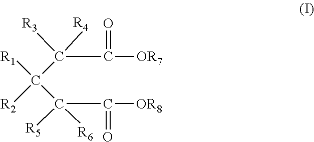
wherein the radicals R₁ to R₈ equal to or different from each other, are H or a C₁-C₂₀ linear or branched alkyl, alkenyl, cycloalkyl, aryl, arylalkyl or alkylaryl groups, optionally containing heteroatoms.

6. The solid catalyst component of claim 5, wherein R₁ is H and R₂ is selected from linear or branched C₁-C₁₀ alkyl, cycloalkyl, aryl, arylalkyl and alkylaryl groups.

7. The solid catalyst component of claim 5, wherein both R₁ and R₂ are different from hydrogen and selected from linear or branched C₁-C₁₀ alkyl, cycloalkyl, aryl, arylalkyl and alkylaryl groups.

8. The solid catalyst component of claim 7, wherein both R₁ and R₂ are selected from C₂-C₅ linear alkyl groups.

9. The solid catalyst component of claim 5, wherein R₇ and R₈ are primary alkyl, arylalkyl or alkylaryl groups having from 1 to 10 carbon atoms.

10. The solid catalyst component of claim 1, wherein the Ti atom belong to titanium compounds having the formula Ti(OR^{a})ₙX_{y-n} wherein n is between 0 and y; y is the valence of titanium; X is chlorine and R^{a} is a hydrocarbon radical.

11. The solid catalyst component of claim 1 further comprising compounds of metals selected from Cu, Zn, and Bi, wherein the compounds being free of metal-carbon bonds.

12. The solid catalyst component of claim 1 further comprising an additional donor selected the group consisting of esters, ethers, carbamates, thioesters, amides and ketones.

13. A catalyst for the polymerization of olefins comprising the product of the reaction between a catalyst component according to claim 1 and an organoaluminum compound.

14. The catalyst for the polymerization of olefins according to claim 13 further comprising an external donor.

15. A process for the polymerization of olefins of formula CH₂═CHR, wherein R is hydrogen or a hydrocarbon radical having 1-12 carbon atoms, carried out in the presence of a catalyst according to claim 13.
